(19) United States
(12) Patent Application Publication
(10) Pub. No.: US 2016/0071207 A1
(43) Pub. Date: Mar. 10, 2016

(54) METHOD FOR WEIGHTING A CREDIT SCORE AND DISPLAY OF BUSINESS SCORE

(71) Applicant: REMETER LLC, CHICAGO, IL (US)

(72) Inventor: Scott H. Openlander, Chicago, IL (US)

(21) Appl. No.: 14/937,125

(22) Filed: Nov. 10, 2015

Related U.S. Application Data
(63) Continuation of application No. 14/476,926, filed on Sep. 4, 2014.

(51) Int. Cl. G06Q 40/02

(52) U.S. Cl. CPC G06Q 40/025

(57) ABSTRACT

A method for displaying a credit score for financial transactions can be used for such business endeavors such as a lease or purchasing property. The weighting system display financial data scoring with respect to industry information in order to transform financial data and industry information to a score by establishing numeric benchmark values and display a score with regard to financial factors related to the business transaction.

This application claims priority to and is a continuation of U.S. application Ser. No. 14/476,9n, filed Sep. 4, 2014.

A display system for business weighting of a credit score provided for determining the credit of a business or individual in order to display a score with respect to financial criteria.

### BACKGROUND

Financial ranking systems are known with respect to ranking credit worthiness of businesses. For example, Dun & Bradstreet (D&B) is well known for providing financial data with respect to businesses. However, the D&B system relies mainly on scoring how well a business pays their creditors. There's very little other information about the financial practices or financial risk such companies have taken. D&B receives its information on a volunteer basis from companies and as a result only collects data from about 4% of U.S. businesses. A Paydex score is provided also but it only uses approximately 2% of all bills paid by a company to measure credit risks. Currently D&B other business credit bureaus only look at how prompt a business or individual pays its top vendors i.e., the Paydex score or FICO score. These short term measures of success don't really provide a long term view on how well a business perform over a 5 or 7 year lease period.

The Risk Management Association (RMA) also provides financial analysis. RMA collects data from its member institutions who provide data on a volunteer basis. So the RMA data is based on only 1% of U.S. businesses and is very limited with respect to the industry breakout in financials per industry. Also the RMA breaks its data out into only 6 regional areas and 21 financial line items. RMA does not provide market sizing nor rent expense benchmarking.

In view of the current state of means of tracking business financial stability and credit the current data is incomplete and error prone. Tests have proven that data in this marketplace is poor and studies have concluded that errors of 75% by orders of magnitude are found with the data and 30-60% of the data is overstated with regard to income versus the actual income reported on IRS tax returns.

Secondary survey-based systems are also inconsistent and have poor data quality and lack of critical mass of companies reporting. An analytical system that more accurately provides financial data regarding business, credit worthiness and risk including lease transactions is provided by the present invention.

### SUMMARY OF THE INVENTION

The invention provides a method of displaying a credit score for a financial transaction comprising the steps of receiving at a computer server, financial data for a tenant via a data input module, the financial data having multiple data points, receiving at the computer server, industry information via an industry peer group sorting module, the industry information having multiple data points, receiving at the computer server, information relating to a lease structure for the tenant via the data input module, comparing using the computer server, the multiple data points of the financial data to the multiple data points of the industry information via the benchmarking sub-process module in order to transform the financial data and industry information by establishing numeric benchmark values to derive a credit score with regard to financial factors related to the lease transaction, recalculating the computer server, via the recalculating module, the credit score based on the lease structure information; and transmitting from the computer server, via the transmitting module, the modified credit score for display on a client machine.

The present invention provides for a method of a computer system having a computer server for establishing a financial ranking for a party to a financial transaction comprising the steps of receiving at the computer server financial data for a party, the ranking may be a tenant, industry and the lease ranking. Receiving at the computer server industry information, comparing using the computer server the financial data to the industry information in order to transform the financial data industry information by establishing numeric benchmark values to derive a ranking with regard to financial factors related to the transaction and transmitting from the computer server the ranking for display on a client computer.

In an embodiment, the ranking provides a credit score for a party to a transaction. In an embodiment, the step of assigning an industry code based on an NAICS code to identify a particular industry and comparing the party with its peers based on the NAICS code and breaking out the ranking by one of a zip code, county, state, or metropolitan statistical area (MSA) region or nationally. In an embodiment, the ranking supports a credit score for a transaction that may be used by a credit bureau and a weighting factor applied to information being compared to determine the ranking. In an embodiment the industry information includes tax return data and data relating to the industry of the party including multiple financial data points of comparable parties including Internal Revenue Service data received from a data base of at least 140 MM individuals and 27 MM businesses covering at least 10 previous years of tax return data. In an embodiment, the industry information is incorporated with data from one of the U.S. Census Bureau and Bureau of Labor. In an embodiment, the ranking is used to adjust a financial agreement, contract or lease amount or breakeven point in order to improve the ranking.

In another embodiment, the invention provides a method of a computer system having a computer server for ranking a lease transaction comprising the steps of receiving at the computer server, financial data for a tenant via a data input module, financial data having hundreds of data points, receiving at the computer server, industry information via an industry peer group sorting module, the industry information having hundreds of data points, receiving at the computer server, information relating to a lease structure for the tenant via the data input module, comparing using the computer server, the hundreds of data points of the financial data to the hundreds of data points of the industry information via the benchmarking sub-process module in order to transform the financial data and industry information by establishing numeric benchmark values to derive a ranking with regard to financial factors related to the lease transaction, recalculating using the computer server, via the recalculating module, the ranking based on the lease structure information and transmitting from the computer server, via the transmitting module, the modified ranking for display on a client machine.

In an embodiment the invention provides a numeric credit score for a first lease transaction and the numeric credit score correlates with the percent by which the ranking exceeds its peers in a corresponding data set and the computer system for simultaneously processing thousands of lease transactions received from thousands of users and providing thousands of numeric credit scores based on thousands of data points of industry information.

The invention further comprises a method of a computer system having a computer server for ranking a lease transaction comprising the steps of receiving at the computer server financial data for a tenant, receiving at the computer server industry information, receiving at the computer server information relating to a lease structure or loan for the tenant, comparing using the computer server the financial data to the industry information in order to transform the financial data and industry information by establishing numeric benchmark values to derive a ranking with regard to financial factors related to the lease transaction, recalculating using the computer server the ranking based on the lease structure information and transmitting from the computer server the modified ranking for display on a client machine.

In an embodiment, the numeric benchmark values are derived by comparing the frequency of a score of interest to each individual item and applying a weighting factor applied to information being compared to determine the ranking. In an embodiment, the numeric benchmark values are derived by comparing the number of benchmarks that are less than a benchmark value percentile rank with a number of benchmarks which have the same value as the benchmark value of the percentile rank. In an embodiment, the numeric benchmark values are derived by a percentile ranking according to the following formula:

$$PR = \frac{{f}_{b} + \frac{1}{2} fw}{N} * 100$$

In an embodiment, the industry information includes government data comprising tax return data, the industry information pertaining to the industry of the tenant including multiple financial data points of comparable tenants.

In an embodiment, the ranking provides for one of scoring of the tenants' financial performance, scoring of the tenants' industry financial performance and scoring of the lease structure for a commercial transaction period and ranking a lease transaction. In an embodiment, the method comprises the steps of adjusting the lease structure, rent amount or breakeven point, each in order to improve the ranking. In an embodiment, the method comprises the step of analyzing one of a global watch list, judgment data base, liens database, criminal or civil court records, foreclosure records or bankruptcy filings in order to adjust the ranking period.

In an embodiment, the tenant financial data includes at least 250 data points for each lease transaction and the ranking scale is between 1 to 1000. In an embodiment the ranking is used to determine a lower financial risk for the lease by varying geographic location, rent amount or breakeven point. In an embodiment it, the benchmark values are derived using one of a quintile scoring process, a linear interpolation and an order of magnitude process. In an embodiment, the ranking is used for one of providing peer to peer lease benchmarking, predicting likelihood of lease renewal, predicting likelihood of lease default or providing data to support issuance of default insurance for landlords. In an embodiment, the ranking is used for determining potential business performance, determining risk level for a portfolio of leases or commercial loans, mitigating risk for a portfolio of leases, providing risk adjusted cap rate for a building sale or purchase, determining a rate for a commercial industrial office or retail REIT or determining a rate for a commercial mortgage bank security.

The invention further comprises a computer program product stored on a non-transitory computer readable medium, the computer program product having computer executable code instructions that are executable on a computer server to calculate lease risks ranking, the computer executable code instructions comprising first code instructions for receiving financial data for tenants, second code of instructions for receiving industry information relating to the industry of the tenant including multiple financial data points of comparable tenants, third code instructions for receiving information relating to a lease structure for the tenant, fourth code instructions for preparing the tenant financial information to the tenant industry information, fifth code instructions for transforming the tenant financial data in the industry information by establishing numeric benchmark values to derive a ranking, sixth code instructions for recalculating the ranking based on the lease structure information and seventh code instructions for transmitting the modified ranking for display.

The present invention provides for a Financial Data System to evaluate a commercial real estate tenant using an automated, web based, self-serve platform. The present invention provides an automated, system Credit Score for a commercial lease transaction using a three alternate scoring system. The present invention provides for a third-party credit bureau for determining the credit or risk score for a given commercial real estate transaction.

The present invention provides for an application of a unique data source which has never been available before or used before to evaluate a tenant or an industry in commercial lease transaction. The unique data source is the de-identified US tax return database of 140 MM individuals and 27 MM businesses going back 10 years. The data is harmonized with the US Census bureau to get accurate industry classifications and establishment level data. The data is also harmonized with the Bureau of Labor data to get accurate employment and payroll data at the establishment level. The present invention provides for a unique methodology for scoring of commercial lease transaction including a business method for reducing the risk inherent in a commercial lease transaction thru the creations of an automated, self-serve risk mitigation platform.

The present invention platform does the following to reduce risk:

the invention provides the go-to data source for data on all commercial lease transactions. The system can capture actual lease transaction comps because this data must be accurately provided to determine the lease risk credit score. Unlike other organizations that rely only on volunteered data, this present invention will have a massive repository of a large percentage of the 2 MM in annual lease transactions. The system can capture up to 150 data points for each lease transaction. The system includes a very valuable database for the commercial real estate industry.

The invention provides a predictive analytics tool for looking at the likelihood of commercial lease renewal or default. Once the system determines our predictive capability for scoring a commercial lease, then the system can use this same methodology to determine likelihood of lease default or renewal 1, 2 or 3 years out, possibly even longer. The invention provides a big data and analytics tools for corporate clients to conduct peer to peer benchmarking.

The invention provides a new business method for looking at a prospect for a commercial lease space without obtaining the full blown financial information or other due diligence items. By looking at the industry down to the NAICS level, the zip code or county code or other geographic area, and the size of the business, the system can determine the business performance with a high degree of accuracy using the system's unique data source.

The invention provides a financial data for determining the true risk level in a portfolio of leases using techniques and methodology for determining the credit risk of individual tenants.

The invention provides the concept of a credit risk score for an entire portfolio based on the accumulation of the individual credit scores of the underlying leases. The ability to suggest ways to diversify a portfolio or mitigate the risk in a portfolio of leases or properties. The invention provides the ability to determine a “Risk-adjusted cap rate” for a building sale or purchase. Using the present invention methodology and scoring, this will have a much higher value of credibility and accuracy. The invention provides the ability to determine a rating for a commercial, industrial or retail REIT based on data never available before. The invention provides the ability to determine a rating for Commercial Mortgage Backed Securities (CMBS) based on underlying lease values. This present invention provides credit scores for the tenants and properties.

The invention provides a new financial data ranking system for determining the credit of a business or individual based on much more than how well they pay their creditors. This present invention analyzes of a number of key financial benchmarks and determines where the tenant and the tenant's industry performs relative to the distribution of the peer group.

The present invention ranks where the tenant stands based on a direct comparison with ALL other participants in a given industry down to the NAICS6 level and down to a given zip code, county, state or MSA and analyzes financial data to evaluate a commercial real estate tenant using an automated, web based, self-serve platform. Benefits are consistency; quick turnaround; repeatable automated data feeds; automated scoring; business assessment of tenant's industry; financial assessment of tenant and assessment of lease structure. The invention provides an automated, system promulgated Credit Score for a commercial lease transaction using a three dimensional scoring system taking into account the financials of the tenant; the strength of the tenant's industry; the strength of the lease structure. The invention provides a third party credit bureau for determining the credit or risk score for a given commercial real estate transaction.

The invention provides a unique methodology for scoring of commercial lease transaction including a) methodology for scoring of a tenant financial and business performance; b) methodology for scoring of a tenant's industry financial and business performance; c) methodology for scoring of the lease structure for a commercial transaction; methodology for scoring the combination of items a, b, and c above.

The invention provides a business method for reducing the risk inherent in a commercial lease transaction thru the creations of an automated, self-serve risk mitigation platform. The platforms does the following to reduce risk: a) permits landlord/broker to adjust the lease structure to mitigate the risk and improve the credit score; b) provides OFAC compliance automatically by checking to see if the tenant or individual is on any global watch lists; c) benchmark data offers a way to suggest improvement in tenant performance if poor; d) automatically checks for business judgments, liens, civil court records, foreclosures, bankruptcies and other risk factors for a business; and e) automatically checks for individual judgments, liens, civil court records, foreclosures, bankruptcies and other risk factors for a business.

The present invention will become the go-to data source for data on all commercial lease transactions. The invention can capture actual lease transaction data comparables because this data must be accurately provided to determine the lease risk credit score. Unlike other organizations that rely only on volunteered data, the present invention will have a massive repository of a large percentage of the 2 MM in annual lease transactions. The invention can capture up to 150 data points for each lease transaction.

The invention provides a predictive analytics tool for looking at the likelihood of commercial lease renewal or default. Once a predictive capability for scoring a commercial lease is provided, then the system can use this same methodology to determine likelihood of lease default or renewal 1, 2 or 3 years out, possibly even longer. The invention provides a new insurance product for commercial real estate that is sold to landlords so they can buy insurance based on the predictive likelihood that a commercial tenant will default over a given time horizon.

Frequency distribution, in statistics, includes a graph or data set organized to show the frequency of occurrence of each possible outcome of a repeatable event observed many times and such frequency distribution is used by the present invention.

For large data sets, the stepped graph of a histogram is often approximated by the smooth curve of a distribution function (called a density function when normalized so that the area under the curve (FIG. 8) is 1). The famed bell curve or normal distribution is the graph of one such function. In an embodiment, a percentile is a measure that tells us what percent of the total frequency score data or below that measure. In an embodiment, a percentile rank is the percentage of scores that fall at or below a given score.

The present invention:
Provides risk assessment of single lease for acquisitions, dispositions, and leasing;
Analyzes a portfolio of leases to aggregate industry and credit risks. Builds on the individual tenant scores to provide an aggregate risk scoring and will identify opportunities for portfolio balancing and risk reduction;
Analyzes commercial lease guarantors ability to assume commercial lease obligations. Evaluates personal financials, utilizing new data feeds from the US government based on individual US tax returns to provide a much more accurate credit score;
Consistent and repeatable methodology; capture and deploy credit best practices in an automated scalable platform which is easy to use and understand;
Permits landlords to take greater risk on the right tenants; and to take stronger positions in negotiations;
Fosters better lease revenue and capital budgeting forecasts and improves risk management;
Speeds up the deal negotiation
Provides fast turnaround time for reports.
Groups industry peer group benchmarks into quartiles, including low and high data points;
Provides quartiles that represent two standard deviations and include low and high bench marks of total data set;
Compares tenant's benchmarks to Industry peer group data sets;
Provides percentile rank of a raw score interpreted as the percentages of results in the norm group who scored at or below the score of interest: Percent Rank Methodology relies on mathematical formula:

$$PR = \frac{{f}_{b} + \frac{1}{2} fw}{N} * 100$$

f_{b} is the frequency below; the number of benchmarks which less than the benchmark value percentile rank

f_{w} is the frequency within; the number of benchmarks which have the same value as the benchmark value of the percentile rank, and

N is the number of benchmarks,

f_{b} is calculated according to the following formula:

$${f}_{b} = \frac{{n}_{i}}{\sum {n}_{i}}$$

Where nᵢ is the frequency of an individual item; and Σnᵢ is the total frequency.

If the distribution is normally distributed, the percentile rank can be inferred from the standard score.
Scoring of each benchmark 1 to 1000, based upon percent ranking;
Weighting each benchmark based on the total score, for example;
   I. Sales Growth is scored 670 out of 1000 individually based upon percent rank. The score of 670 means this benchmark ranks better than 67% of its peers in the data set.
   II. Sales growth is 5% of total score and calculated value of total score is 33.5 of the total score of 1000.
      AD benchmarks are percent ranked, scored then summed to achieve an overall weighted score.

### BRIEF DESCRIPTION OF THE DRAWINGS

FIG. 1 is a schematic diagram of the present invention;

FIG. 2 is a flow diagram of the functionality of the present invention;

FIG. 3 is a flow diagram of the data input functionality of the present invention;

FIG. 4 is a flow diagram depicting an alternate quintile scoring method of the present invention;

FIG. 5 is a flow diagram depicting an alternate linear interpolation process of the present invention;

FIG. 6 is a flow diagram of an alternate benchmark scoring order of magnitude process of the present invention;

FIG. 7 is a flow diagram depicting an alternate percent rank process of the present invention;

FIG. 8 is a percentile ranking curve used in the present invention;

FIG. 9 is a diagram indicating risk levels used by the present invention;

FIG. 10 depicts an exemplary screen shot illustrating an implementation of the present invention where property and tenant information is input;

FIG. 11 is an exemplary screen shot of the present invention depicting input of tenant financial information;

FIG. 12 is an exemplary screen shot an implementation of the present invention illustrating the input of further lease information;

FIG. 13 is an exemplary screen shot of the present invention illustrating an embodiment for the input of lease base rent information;

FIG. 14 is an exemplary screen shot of an implementation of the present invention illustrating the input of recoverable expense information for a tenant;

FIG. 15 is an exemplary screen shot illustrating an implementation of the present invention where additional lease terms may be input;

FIG. 16 is an exemplary screen shot depicting an implementation of the present invention illustrating a dashboard and the ranking via a Tenant, Industry, Lease score;

FIG. 17 is an exemplary screen shot of an implementation of the present invention depicting tenant assessment information including risk options;

FIG. 18 is an exemplary screen shot of the present invention depicting an implementation for the assessment of pertinent industry data;

FIG. 19 is an exemplary screen shot depicting an implementation of the present invention including lease assessment data including lease terms.

FIG. 20 is an exemplary screen shot of the present invention depicting an implementation presenting capital structure and Tenant Industry vs. US Economy information;

FIG. 21 depicts an exemplary screen shot for an implementation of the present invention illustrating a tenant assessment information; and

FIG. 22 depicts an exemplary screen shot for an implementation of the present invention illustrating a tenant assessment information

The above drawing figures depict only embodiments which are presently preferred and the invention is not limited to such disclosed embodiments or the precise arrangements and instrumentality shown.

### DETAILED DESCRIPTION

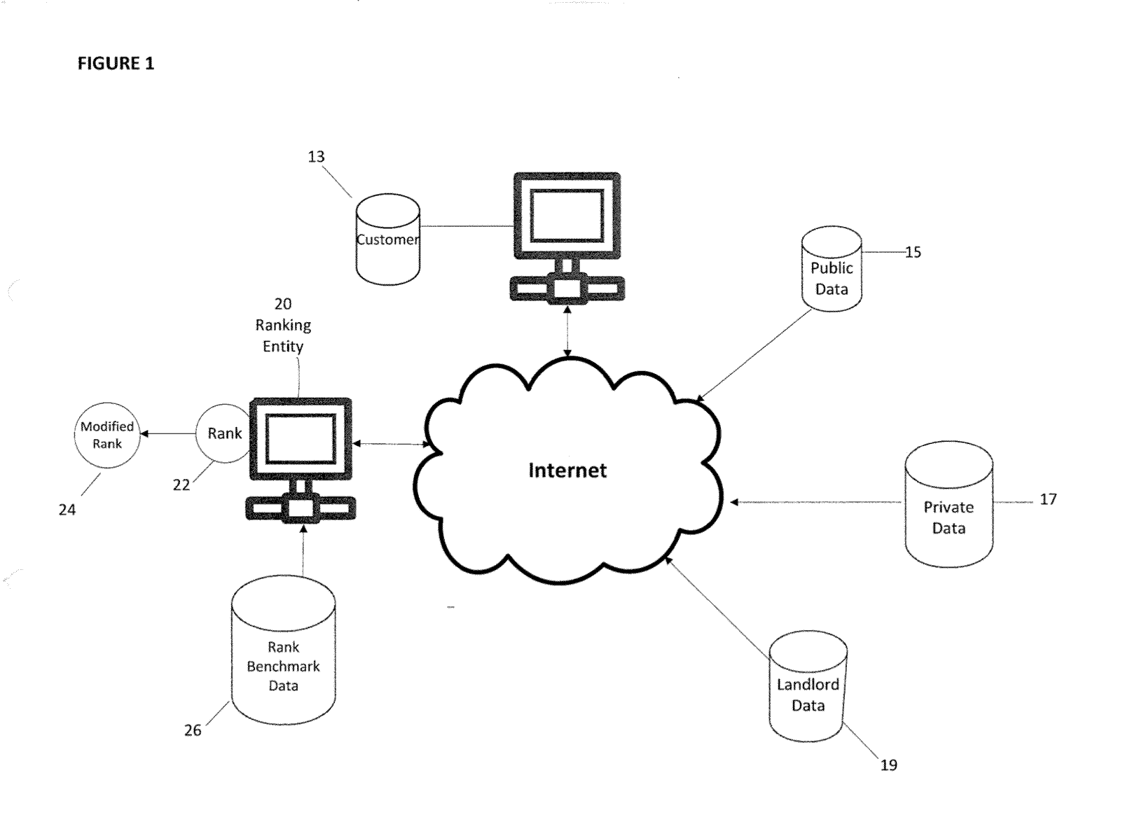

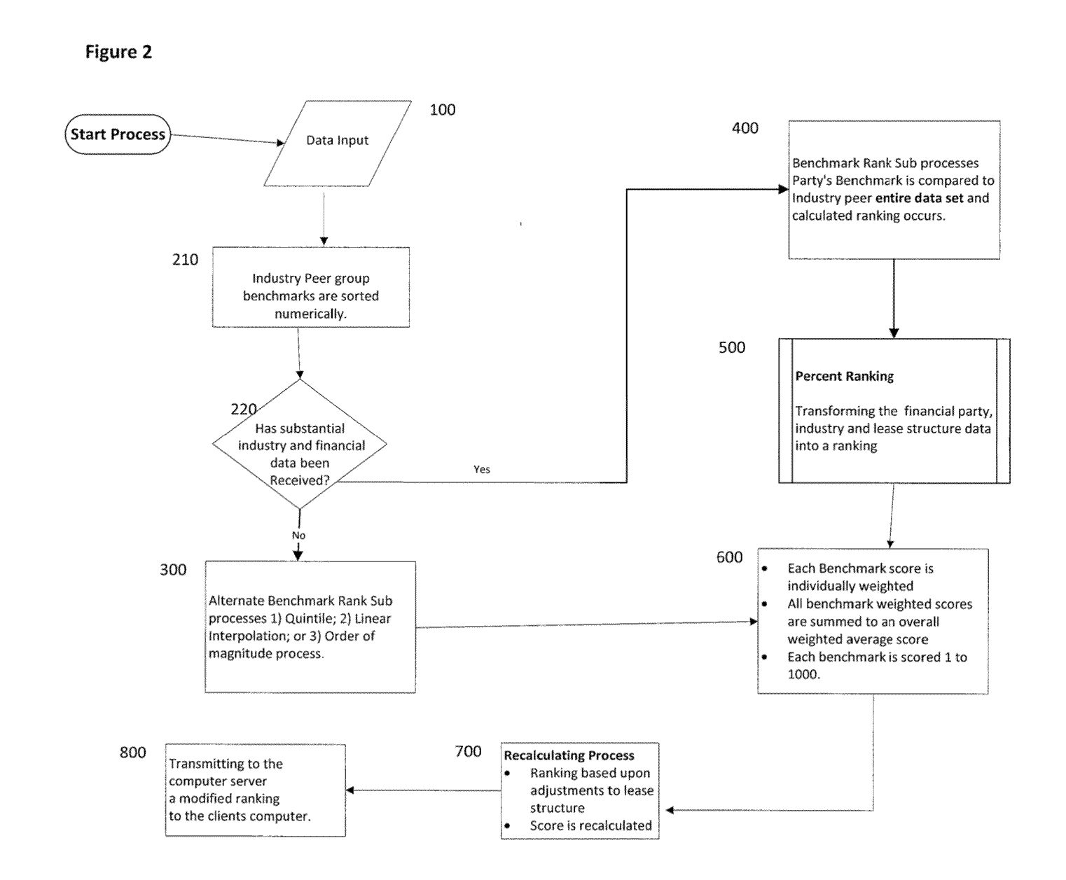

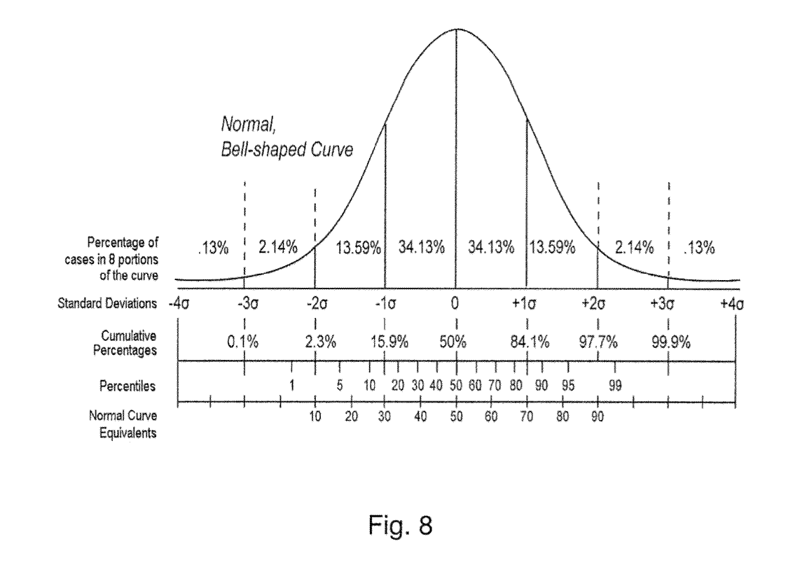

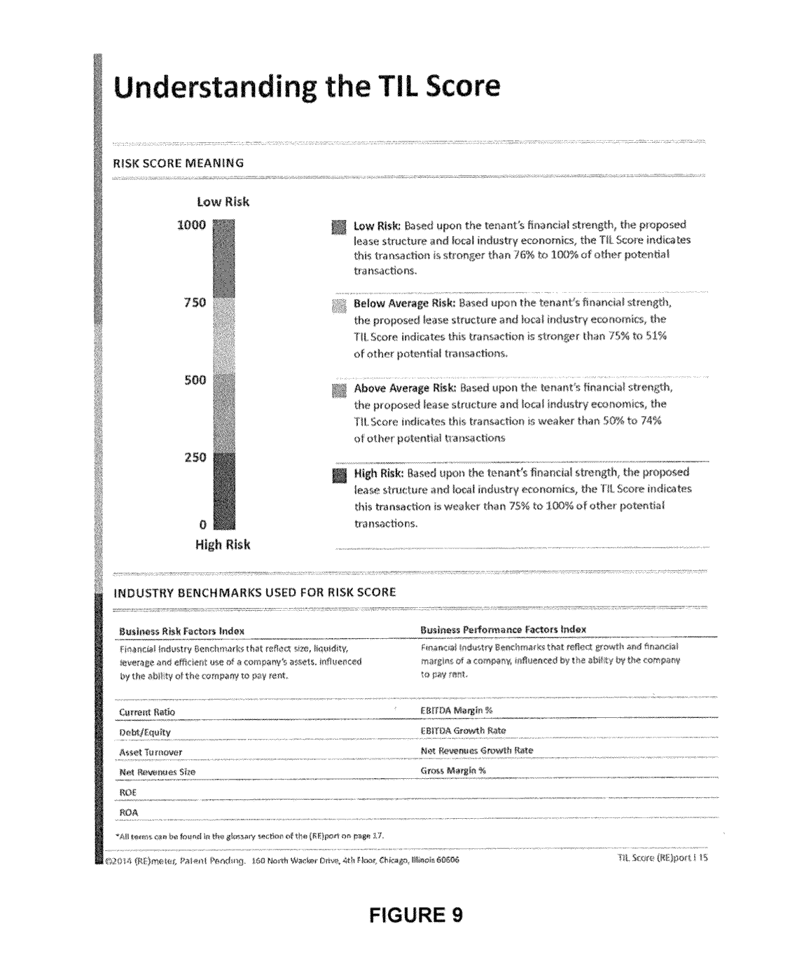

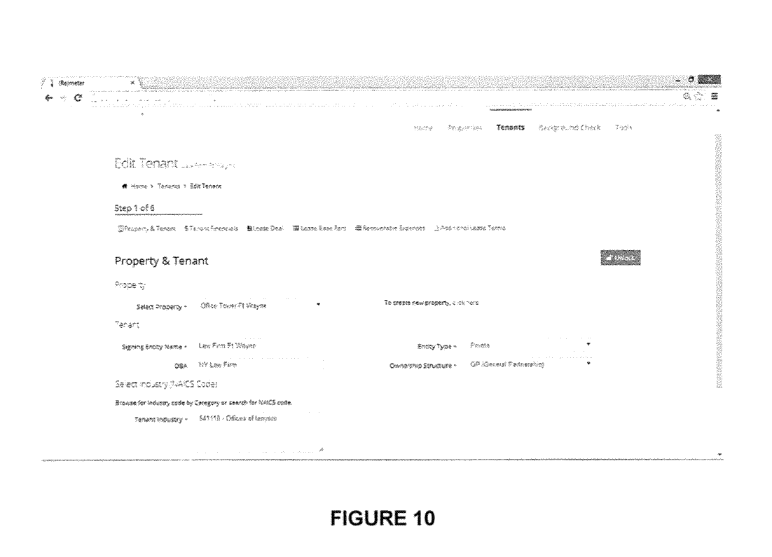

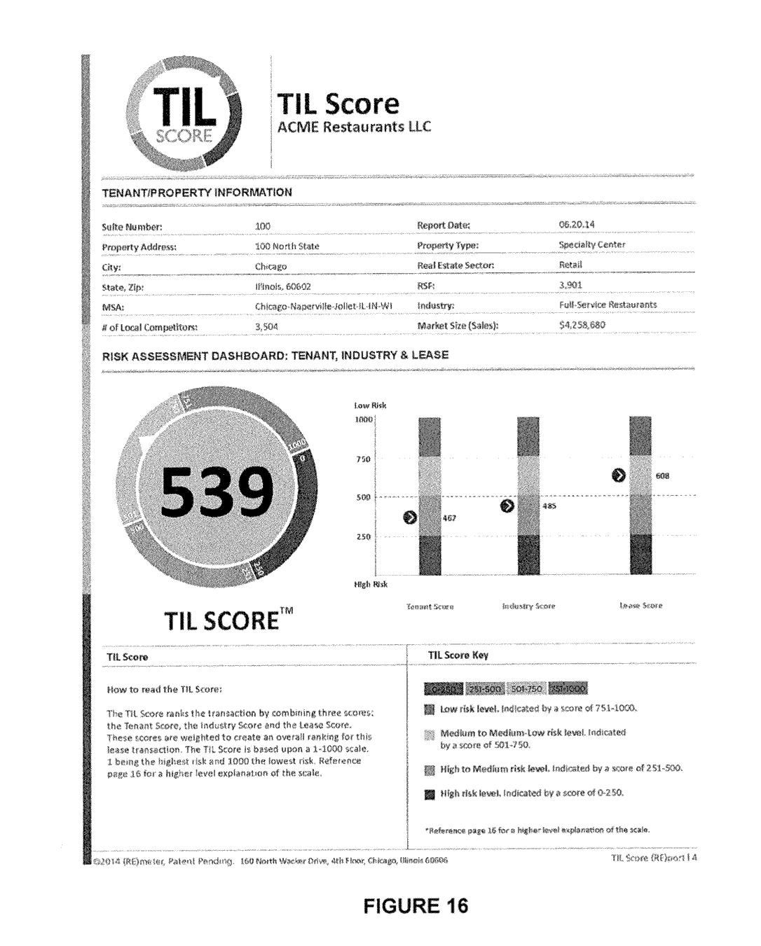

FIGS. 1-22 depict an embodiment of the tenant, industry and lease ranking invention. In particular, FIG. 1 is a schematic diagram of the invention; FIGS. 2-7 depict flow diagrams of the operation of the present invention; FIGS. 8-9 depict diagrams relating to the present invention; FIGS. 10-15 depict screen shots for inputting information and FIGS. 16-22 depict screen shots for display of ranking results of the present invention.

FIG. 1 depicts a schematic diagram of the present invention and some of the hardware components of the financial ranking system. Server 20 is the ranking entity server which receives financial data and industry information in order to transform the financial data and industry information by establishing a numeric benchmark value and derive a ranking with regard to financial factors related to a financial transaction, such as a lease, which is represented by the rank output 22. The rank output is then recalculated by the server 20 with respect to the lease structure information to provide a modified ranking result 24, which is available for display by a customer or a client via server 13.

The server 20 receives data externally by the internet, in an embodiment, including public data 15 private data 17 and landlord data 19. The server 20 is also linked to a database that includes rank or benchmark data regarding the specified industries, such as the leasing industry. In an embodiment public data 15 includes data from the Internal Revenue Service (IRS) the U.S. Census Bureau and the Bureau of Labor. In a preferred embodiment the data may be harmonized, de-segregated and cleaned by a third party vendor. In an embodiment, the IRS data will include data of at least 140 MM individuals and 27 MM businesses covering at least 10 previous years of tax return data. The private data 17, in an embodiment, may include global watch list information, judgment data base, liens data base, criminal or civil court records, foreclosure records or bankruptcy filings. In addition private data may include data from sources such as Dun & Bradstreet or RMA. The benchmark data 26 may include industry codes including NAICS codes for particular industries and sorted by zip code, county, state or metropolitan statistical area (MSA), state, region or nationally.

A customer using computer or server 13 may access the information sent from the ranking entity server 20 and may input data via their computer 13 to be received by the ranking entity server 20 in order to complete the process to obtain ranking information. For example, the customer 13 may be a bank, insurance company or REIT, determining whether a lease transaction is appropriate. The invention also is appropriate for other financial transactions and can provide ranking and benchmarking information for other types of industries such as insurance, intellectual property or transportation.

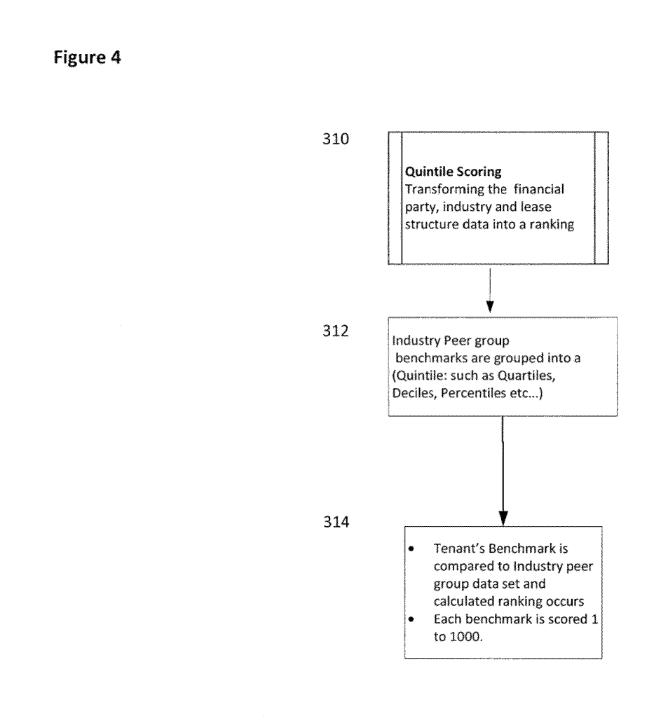

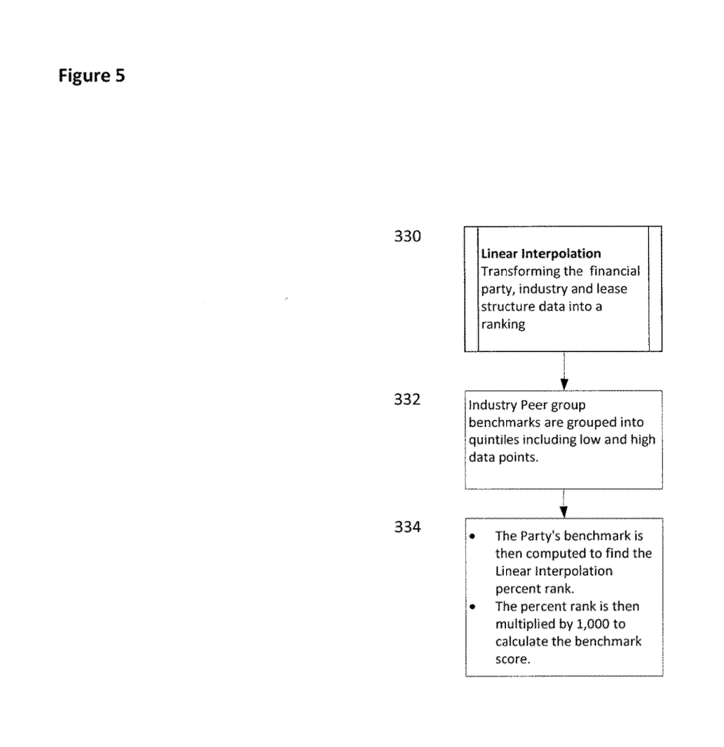

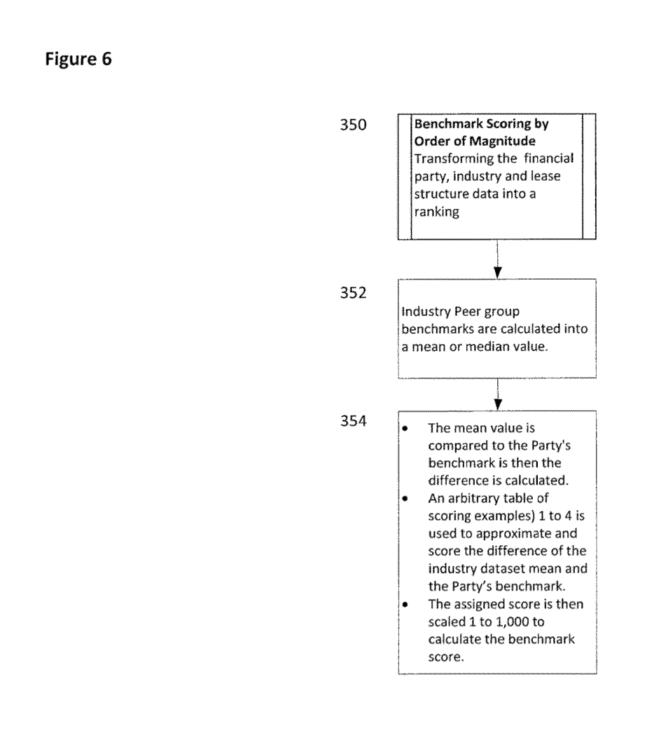

Turning to FIGS. 2-8 the steps for operation of the financial benchmarking system will be discussed. Turning to FIG. 2 the invention includes data input module 100, industry peer group sorting module 210, alternate benchmarking module 300, benchmarking sub-process module 400, percent ranking module 500, weighting and scoring module 600, recalculating module 700 and transmitting module 800. The invention also includes Quintile scoring module 310 (FIG. 4), linear interpolation module 330 (FIG. 5) and order of magnitude scoring module 350 (FIG. 6). Such modules include code for reading from look up tables or SQL tables and may also run as applications according to software programming standards.

Data input occurs at data input module 100 (FIG. 2) and the data is sorted into industry peer group segments and benchmarks are sorted numerically at step 210. At step 220 the server determines whether a substantial industry and financial data has been received. If the appropriate data including industry and financial data has been received at step 220 the process moves forward to a benchmark and ranking step 400. If at step 220 the server determines that there is not sufficient industry and financial data then alternate benchmark and rank sub processes are followed at step 300. Those processes include quintile process, linear interpolation or order of magnitude processes to determine a rank. While the preferred method of providing a benchmark rank uses a percent ranking process, these alternate benchmark ranking sub-processes may be used (but their characteristics and different data output capabilities must be recognized).

The quintile scoring method is generally an arbitrary method where the benchmark vs. industry groups are split between low risk, low to middle risk, mid risk, high to middle risk and high risk. A score is set for each level where low to middle risk is 250, mid risk is 500, high to mid risk is 750 and high risk is 1000 (see FIG. 9). This process is more likely to have more human input to select a quintile ranking based on benchmark data for the lease or other financial transaction compared to industry group data. For example EBITDA percentage may be used to determine which grouping a transaction should be placed.

The word quintile is a generic term which means that the scoring may be grouped in any number of groupings. For example, quartile scoring may be used when the score groupings are 1, 2, 3 and 4, but groupings of 3, 4, 5, 6, 7 or 8 or more scoring segments may be used.

Linear interpolation may be used where 2 values may be graphed using “xy” coordinates and mid-points may be located using linear interpolation for example a formula such as

$$y = {y}_{o} + ( {y}_{i} - {y}_{o} ) \frac{x - {x}_{o}}{x - {x}_{1}}$$

Where (x_{—}0,y_{—}0) and (x_{—}1,y_{—}1), the two known points are given by the coordinates x a value in the interval (x_{—}0,x_{—}1), y the value along the straight line is given from the equation

Based on the formula that provides the incremental values, a ranking can be obtained but again such incremental values are assigned somewhat arbitrarily and may provide some room for inaccuracy.

### Sample Code for Linear Interpolation Module

<low special case
low<value<lowMid case A
lowMid<value<Mid case B
mid<value<highMid case C
highMid<value<high case D
>high special case

### Case A

incremental Value=(lowMid−low)/25;
percentile=((value−low)/incremental Value)*10;
credit indicator=1000−percentile

### Case B

incremental Value=(mid−lowMid)/25;
percentile=(25+(value−lowMid)/incremental Value)*10;
credit indicator=1000−percentile

### Case C

incremental Value=(highMid−mid)/25;
percentile=(50+(value−mid)/incremental Value)*10;
credit indicator=1000−percentile

Case D
incremental Value=(high−highMid)25;
percentile=(75 +(value−high)/ incrementalValue)*10;
credit indicator=1000−percentile

Turning to FIG. 2, at step 400 the benchmark rank process occurs by comparing a parties benchmark data to industry peer datasets and calculating a ranking. At step 500 the percent ranking system operates by transforming the financial party industry and lease structural data into a ranking. At step 600 the benchmark score is individually weighted, all benchmark weighted scores are summed to an overall weighted average score and each benchmark is scored from 1 to 1000. Step 600 also may be applied following the alternate sub processes of step 300. Thereafter at step 700 a recalculating process occurs where the ranking based upon step 600 are adjusted based on lease structure information. The score is recalculated based on that information. At step 800 the final modified ranking score is transmitted to the customer's computer in order to assist in analyzing whether the financial transaction or lease is appropriate for that customer.

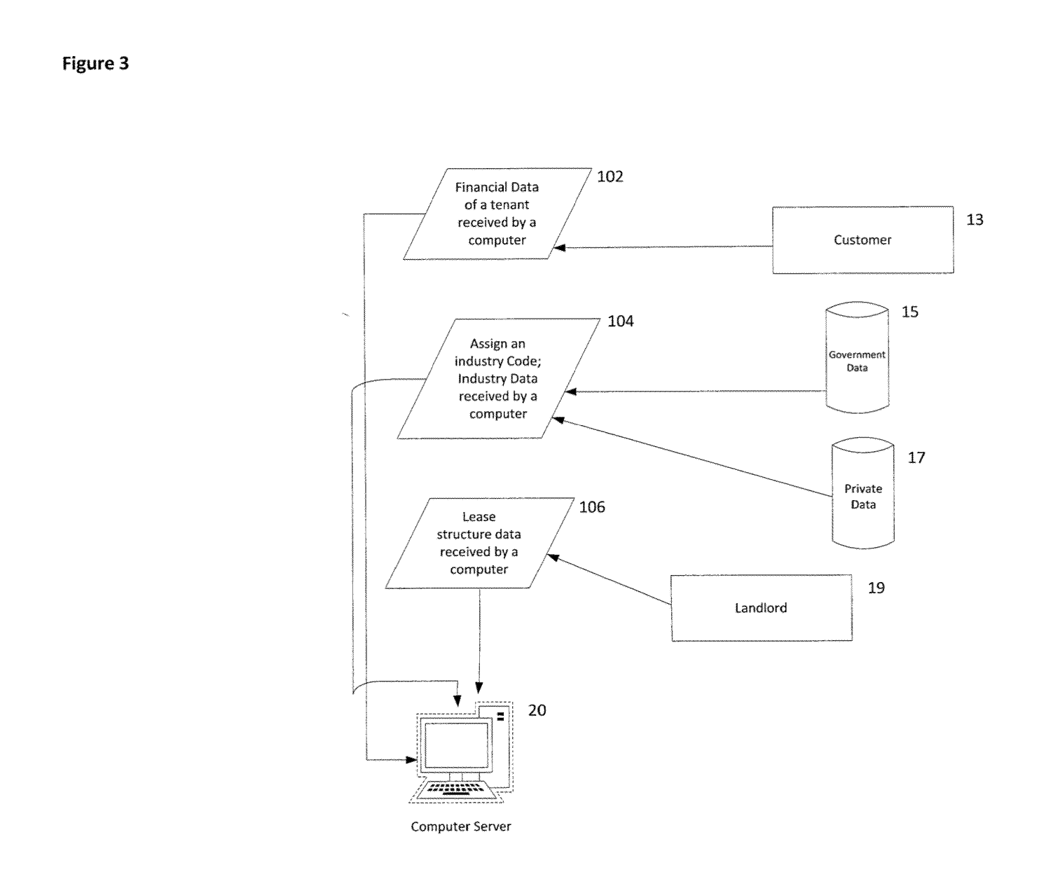

Turning to FIG. 3, a more detailed flow diagram of the data input step 100 is described. Financial data of a customer such as a tenant is received by the server at step 102. The customer 13 may input the data directly from his or her computer via the internet or other means (see description for FIGS. 10-15). Data such as industry code is received by the server 20 at step 104 including government data 15 and private data 17, as discussed previously. The lease structured data is received at step 106. In a preferred embodiment the landlord inputs that data at step 19. All that data is received by server 20 in order to be processed to perform the ranking calculations.

Turning to FIG. 4 the quintile scoring process at step 300 is described in more detail. At step 310 the financial party industry and lease structure data is transformed into a ranking to determine financial issues that may be involved in the transactions. At step 312, industry peer group benchmarks are grouped into quintile groups such as quartiles, deciles or percentiles. At step 314 the tenant's benchmark is compared to the industry peer group dataset and calculated ranking occurs via arbitrary scoring where a parties benchmark alliance with the quintile benchmarks. Those benchmarks are scored from 1 to 1000.

TABLE 1
Quintile Scoring - Arbritary Method

| | | | | | | | Quartile | |
|---|---|---|---|---|---|---|---|---|
| Benchmark | Low | Lowmid | Mid | Highmid | High | Party | Of Data Point | Score |
| EBITDA % | 5.29 | 6.51 | 7.73 | 10.3 | 13.36 | 6.71 | LowMid to Mid | 500 |

Benchmark vs. Industry Group
If tenant < LowMid, then score = 250
If LowMid < tenant < Mid, then score = 500
If Mid < tenant < HighMid, then score = 750
If HighMid < tenant, then score = 1000
Definition Arbritarlity setting a score where the Party's benchmark aligns with the quintiled benchmarks.

Turning to FIG. 5, the linear interpolation process of step 300 is described in more detail. At step 330 linear interpolation occurs by transforming the financial party data, industry data and lease structure data into a ranking based on “x-y” coordinates on a chart. At step 332 industry peer benchmarks are grouped into quintiles including low and high data points and at step 334 the parties benchmark data is computed to find linear interpolation percent rank. The percent rank is them multiplied by 100 to calculate the benchmark score.

Turning to FIG. 6, the benchmark scoring by order of magnitude process of step 300 is described in further detail. Orders of magnitude process also relies on fairly arbitrary assignment of scores based for example on EBITDA percentage of a business or transaction and lining up those scores with the ranking numerical values of 1 through 1000. The system analyzes the difference of party benchmarks to mid-industry benchmark information and providing an arbitrary order of magnitude based on scoring of 1 to 1000. The percent ranking process overcomes some of the arbitrary nature of the alternate benchmark sub-processes.

TABLE 2
Quintile Scoring Orders of Magnitude-Arbritary Method

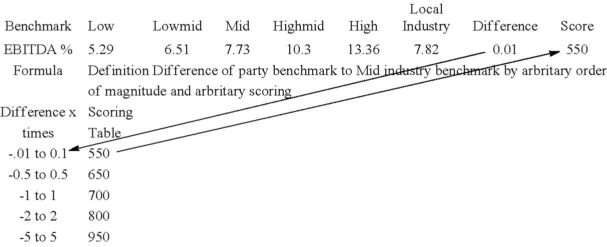

At step 350 the financial party data, industry data and lease structure data is transformed into rank. At step 352, the industry peer group benchmarks are calculated into a mean or median value. At step 354, the mean value is compared to the party's benchmark and then a difference is calculated. An arbitrary table of scoring examples such as 1-4 are used to approximate and score the difference of the industry dataset mean data points and the party's benchmark. The assigned scores then scaled 1 to 1000 to calculate the benchmark score.

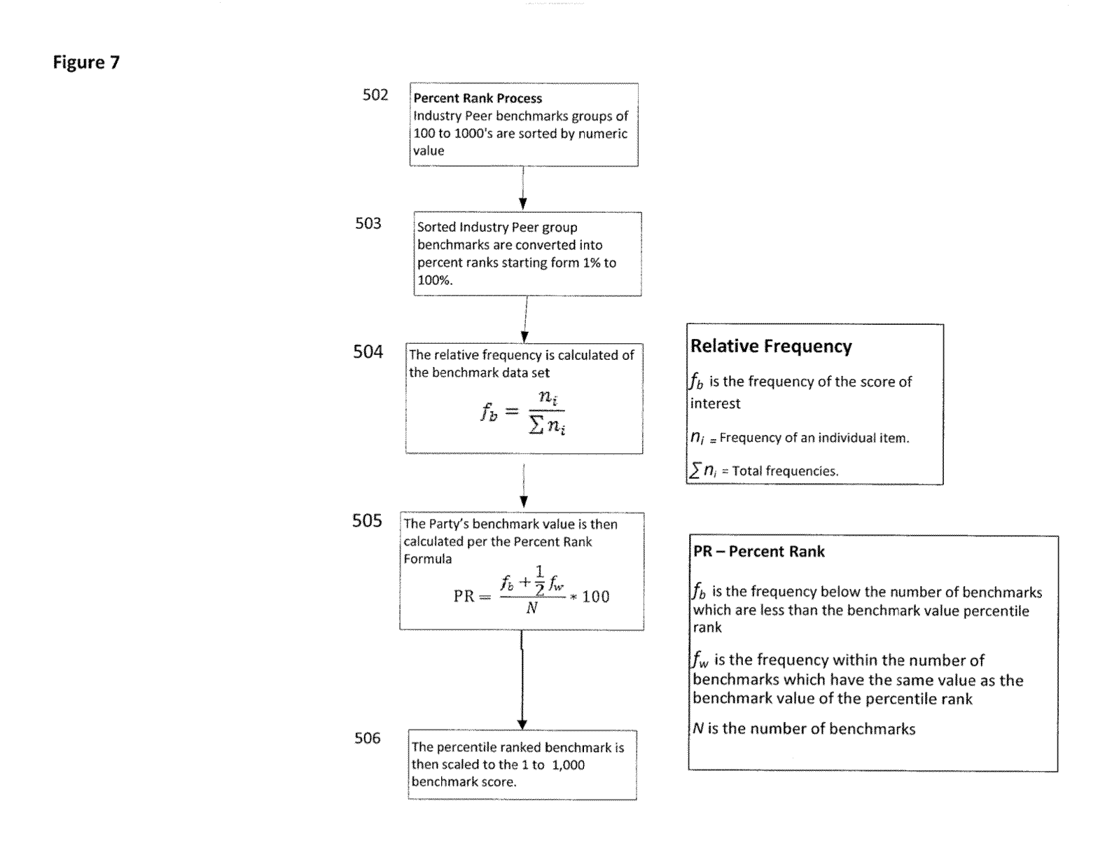

Turning to FIG. 7 the percent rank process is described in more detail with respect to steps 500-506 that are completed, in an embodiment by a specially programmed and outfitted ranking entity server 20 (FIG. 1). At step 502 industry peer benchmark groups are sorted by numeric value. At step 503 the sorted peer industry group benchmarks are converted into percent rank starting from 1% to 100%. At step 504 the relative frequency is calculated by server 20 for the benchmark dataset using the formula:

$$PR = \frac{{f}_{b} + \frac{1}{2} fw}{N} * 100$$

where f_{b} is the frequency below; the number of benchmarks which are less than the benchmark value percentile rank.

$${f}_{b} = \frac{{n}_{i}}{\sum {n}_{i}}$$

f_{w} is the frequency within; the number of benchmark which have the same value as the benchmark value of the percentile rank

N is the number of benchmarks

At step 505 the party's benchmark value is calculated per the percent rank formula of

$$PR = \frac{{f}_{b} + \frac{1}{2} fw}{N} * 100$$

where f_{b} is the frequency that is below the number of benchmarks which are less than the benchmark value percentile rank, F_{W} is the frequency within a number of benchmarks which have the same value as the benchmark value of the percentile rank and N is the number of benchmarks At step 506 the percentile rank benchmark is then scaled to 1 to 1000 to provide the benchmark score.

### Sample Code for Percent Ranking Module:

```
    BEGIN
        Input: arrayOfBenchmarkValues, valueToEvaluate
        Output: percentRank
        Sort arrayOfBenchmarkValues in ascending order
        quartileDataset = CALL reduceDatasetToQuartiles(dataset)
        percentRank = CALL calculatePercentRank(quartileDataset,
        theValue)
    END
    BEGIN reduceDatasetToQuartiles(dataset)
        initialize reducedDataset with 5 elements
        FOR i = 0 TO 4
            percentage = i/4
            N = size of dataset
            k1 = percentage*(N − 1)
            k2 = getX2(dataset, k1)
            f = percentage * (N − 1) −
            TRUNCATE(percentage*(N − 1))
            reducedDataset[i] = dataset[k1] + (f * (dataset[k2] −
            dataset[k1]))
        END FOR
        return reducedDataset
    END reduceDatasetToOuartiles
    BEGIN calculatePercentRank(dataset, theValue)
        FOR frequencyBelow = 0 TO size of dataset
            IF dataset[frequencyBelow] == theValue
                frequencyWithin = calculateFrequencyWithin(dataset,
dataset[frequencyBelow])
                return ((frequencyBelow + 0.5 * frequencyWithin) /
size of dataset) * 1000
            END IF
        END FOR
        FOR i = 0 TO size of dataset
            x1 = dataset[i]
            x2 = dataset[getX2(dataset, i)]
            IF x1 <= theValue && theValue <= x2
                y1 = CALL calculatePercentRank(dataset, x1)
                y2 = CALL calculatePercentRank(dataset, x2)
                return y1 + (((y2 − y1) * (theValue − x1)) / (x2 − x1))
            END IF
        END FOR
        throw Exception(“Out of bounds”)
    END calculatePercentRank
    BEGIN calculateFrequencyWithin(dataset, theValue)
        counter = 0
        FOR i = 0 TO size of dataset
            IF dataset[i] == theValue
                counter++
            END IF
        END FOR
        return counter
    END calculateFrequencyWithin
    BEGIN getX2(dataset, x1Index)
        FOR i = x1Index TO size of dataset
            IF dataset[x1Index] < dataset[i]
                return i
            END IF
        END FOR
        return x1Index
    END getX2
```

Turning to FIG. 8, a standard bell-shaped, curve is depicted which illustrates the distribution of percentages used by the percent rank process as discussed above. The bell-shaped curve depicts the percentage of cases in eight portions of the curve including: 13%, 2.14%, 13.59%, 34.13%, 13/59% 2.14%, and 0.13%. Those eight quintiles are used to numerically arrange the data according to frequency measurements. The y axis of the bell curve chart (i.e., height) represents the number of repetitions of the data. By calculating the standard deviation of the curve, then the benchmark numbers can be derived using the ranking server 20 and to match the points on the curve. For example, if there is data regarding a customer's lease rate, the rate is compared to industry standard rates that are located on the bell curve. The lease rate data along the bell curve is separated into quintiles and the customer's lease rate is placed within the corresponding quintile following to calculations being performed according to steps 502-505 as described in FIG. 7.

The bell curve (FIG. 8) also depicts the standard deviations between −4σ and +4σ and the width of each deviation depicts dispersion of the data. The curve depicts the accumulative percentages between 0 and 100%. The curve depicts the percentiles between and 1 and 100 and the curve illustrates normal curve equivalence between 1 and 100. The calculations, as illustrated by bell curve in FIG. 8 are accomplished by the ranking server 20.

FIG. 9 depicts the assignment of scoring to risk levels according to the scoring method of the present invention, discussed above.

Now turning to FIGS. 10-22 a implementation of the present invention is depicted according to screen shots that help illustrate the present financial ranking system. These screen shots in FIGS. 10-22 are only exemplary and provide a presently preferred embodiment of the invention. However, many alternative sample screen shots or means of accomplishing the invention could be covered under the present claims of the invention.

Turning to FIG. 10, the Edit Tenant process is shown and is step one of six provided for input of information for the financial ranking system. Basic information is input on the Edit Tenant first screen including property name, type of tenant, name of tenant, tenant industry (by NAICS Code). By use of zip code the data is accessed from the industry database.

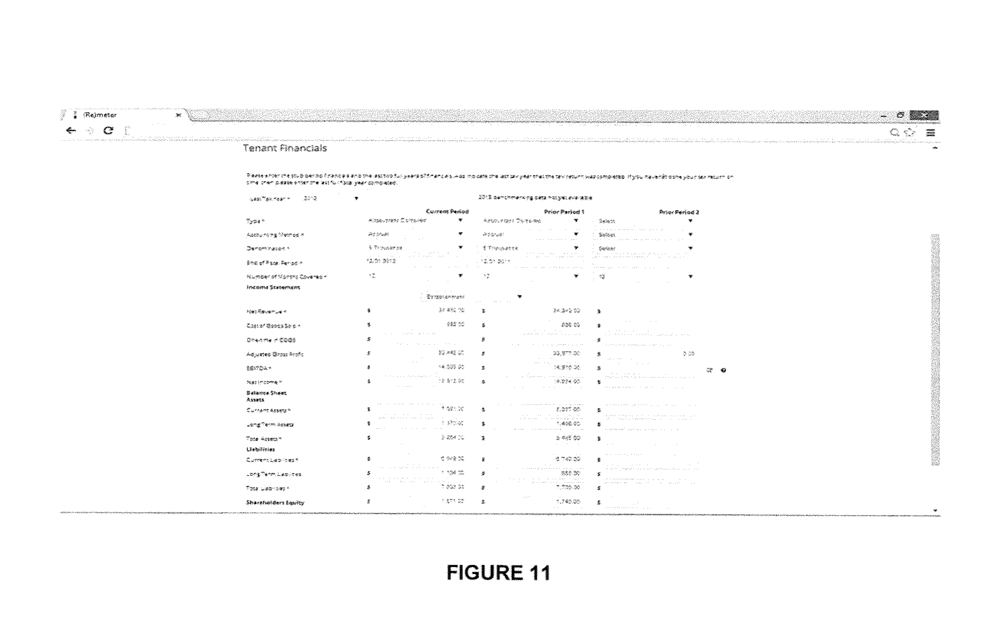

Turning to FIG. 11, step 2 of 6 for input of Tenant Financials is provided by requesting data such as last tax year, accounting type, accounting methods, denominations, end of fiscal period, number of months covered, net revenue, cost of goods sold, one time in COGS, adjusted gross profit, EBITDA, net income, current assets, long-term assets, total assets, current liabilities, long-term liabilities and total liabilities and shareholder equity. This data is requested for the Current Period, Prior Period 1 and The Prior Period 2 columns.

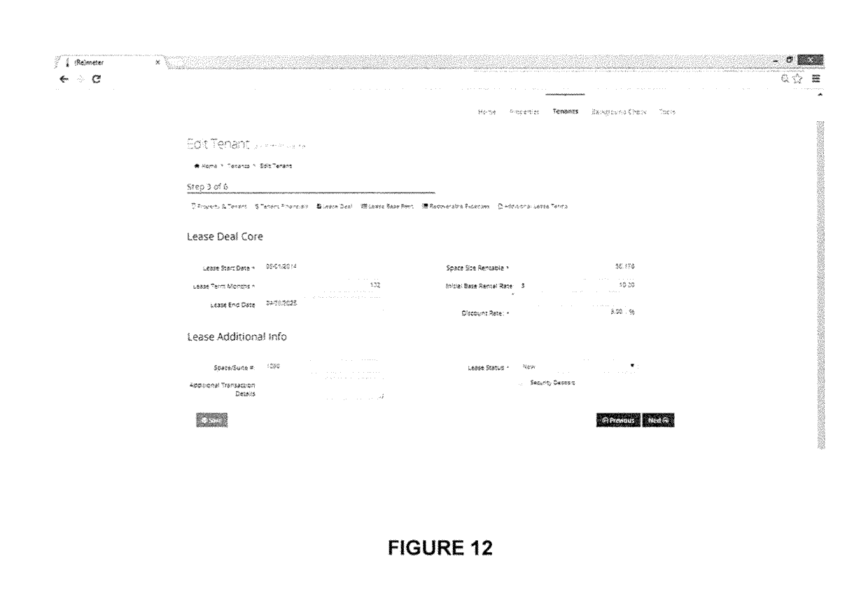

Turning to FIG. 12 the Edit Tenant data step 3 of 6 is provided and requests information including the Lease Deal Core data including the lease start date, lease term months, lease end dates, space size rentable, initial base rental rate and discount rate. The edit tenant data also requests additional information including the suite number, additional transaction details or lease status.

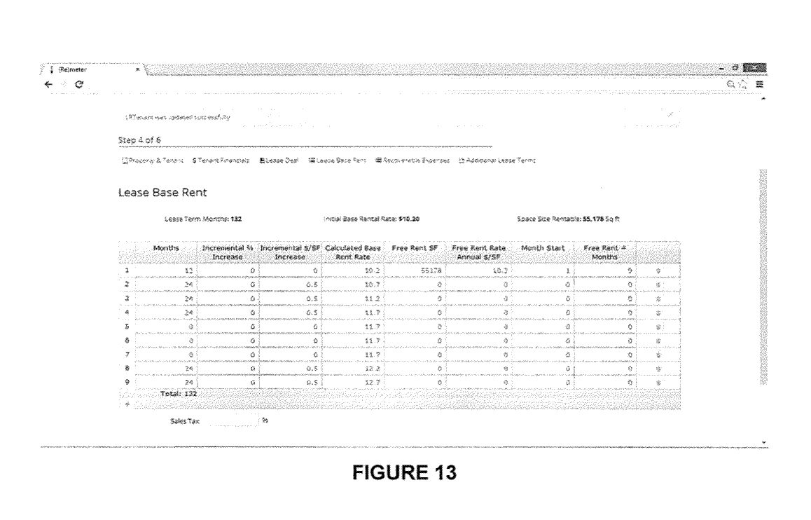

Turning to FIG. 13, the tenant data is inserted at step 4 of 6 including Lease Base Rent by months 1 through 9 showing Incremental Increases, Incremental Square Foot Increase, Calculated Base Rent Rate, Free Rent per square foot, Free Rent Rate annual by dollar per square foot, Month Start and Free Rent by number of months columns.

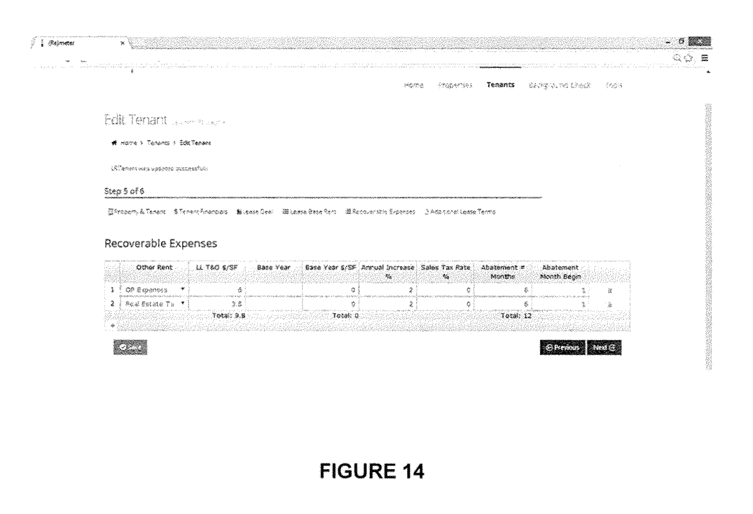

Turning to FIG. 14, the Edit Tenant input screen step 5 of 6 is presented which requests recoverable expenses including OP expenses and real estate taxes provided by LL T&O by dollar per square foot Base Year by dollar per square foot, Annual Increase Percentage, Sales Tax Rate percentage, abatement number of months and Abatement Months Begin columns.

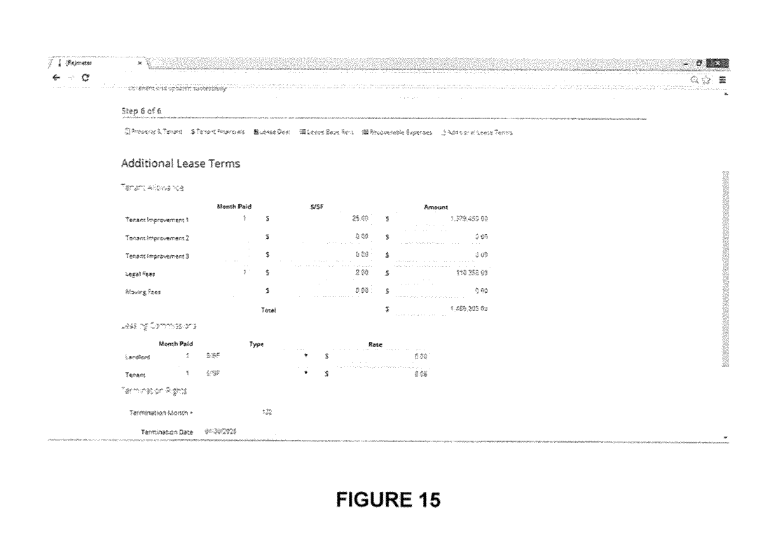

Turning to FIG. 15, the Edit Tenant data input step 6 of 6 requests additional lease terms including Tenant Allowance including Tenant Improvement 1, Tenant Improvement 2, Tenant Improvement 3, Legal Fees, Moving Fees according to the Month Paid, Dollar per Square Footage and the Total Amount columns. The input also request leasing commissions by landlord and tenant according to month paid. Type and Rate columns. Termination rights by termination month and termination date are also provided.

Each of the data input points described above in the screen shots 10 through 15 are received by the server 20 as discussed above and the preferred ranking process is undertaken as described with respect to the flow diagrams 2 through 6 discussed above.

Turning to FIG. 16, a Tenant Industry, Lease (TIL) Score Assessment dashboard is depicted showing in the bar graphs the individual Tenant, Industry and lease score Credit and high/low risk indicators. Ire the Tenant Credit Indicator an arrow at 407 shows that the Tenant score is comparatively high risk, but the correlation to the industry score at 455 is partially in the medium risk level. This data is correlated with the lease structure information. As shown in the bar graph, the Lease Structure score is 608. So when the Tenant, Industry and lease Credit scores are correlated via ranking entity server 20, an overall score credit indicator is “539”.

The Assessment dashboard of FIG. 16 may have sections broken out in more specificity and provide numeric values that are incorporated into the TIL score. As well, the security has weighting that is provided by the system. The weighting is provided by importance level.

The importance level for the overall score may be weighted very highly. As compared to the Importance Level for the Industry score, the Importance Level weighting for the Lease Structure and Tenant information are weighted a bit higher than the Industry data. Specific information supporting the Risk Assessment Dashboard are further included by providing property information, Tenant Information and Lease Structure Information, such as dollar per square foot based on an NPV lease deal and dollar per square foot for an NAR lease deal.

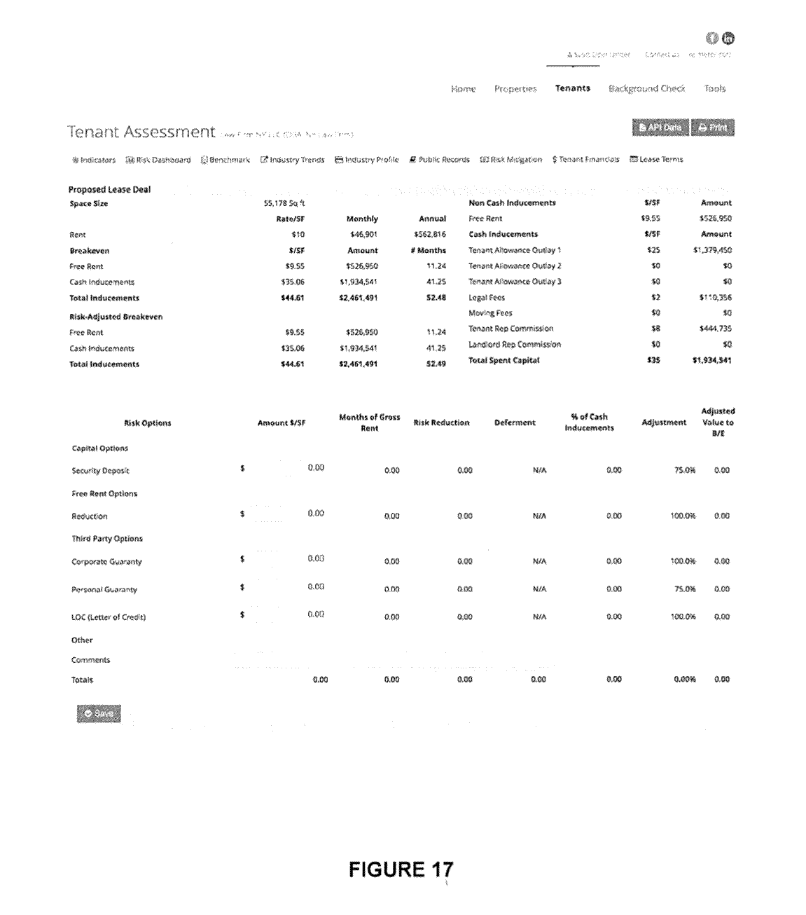

The TIL score and ranking assessment is further delineated according to Tenant Data, Industry Data and Lease Structure Data. Each of these data categories are presented according to screen shots at FIGS. 17-22. The Tenant Assessment in FIG. 17 includes Risk options of Capital Options and Third party options, includes Growth, Profitability, Efficiency ratios and Capital Structure data categories. The Industry Data 1022 includes Growth, Profitability, Efficiency Ratios and Capital Structure data categories. Additional data input may provide input of the Property Name, the Address and Classification by Real Estate Sector.

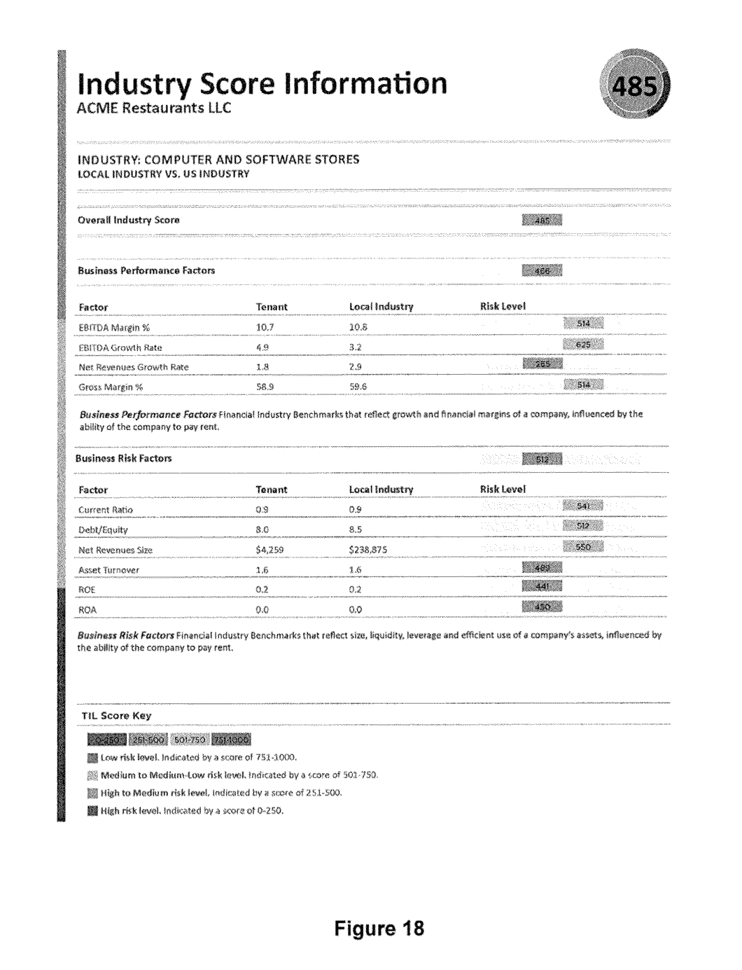

In FIG. 18, Industry ranking Information includes Local Industry v. U.S. Industry benchmarking with respect to business performance factors (or an alternate embodiment compares Tenant Industry vs. U.S. Economy) including Size according to Net Sales; Growth by Sales; percentage, EBITDA Percentage Profitability includes Gross Margin percentage, EBITDA percentage categories. The Industry benchmarking also considers business risk factors including Efficiency Ratios including Asset Turnover, Current Ratio, ROA percentage, ROE percentage. The chart includes Capital Structure including debt to equity ratios. These are all ranked according to Industry Locale, Industry in the U.S., Credit Indicator and Risk Level columns.

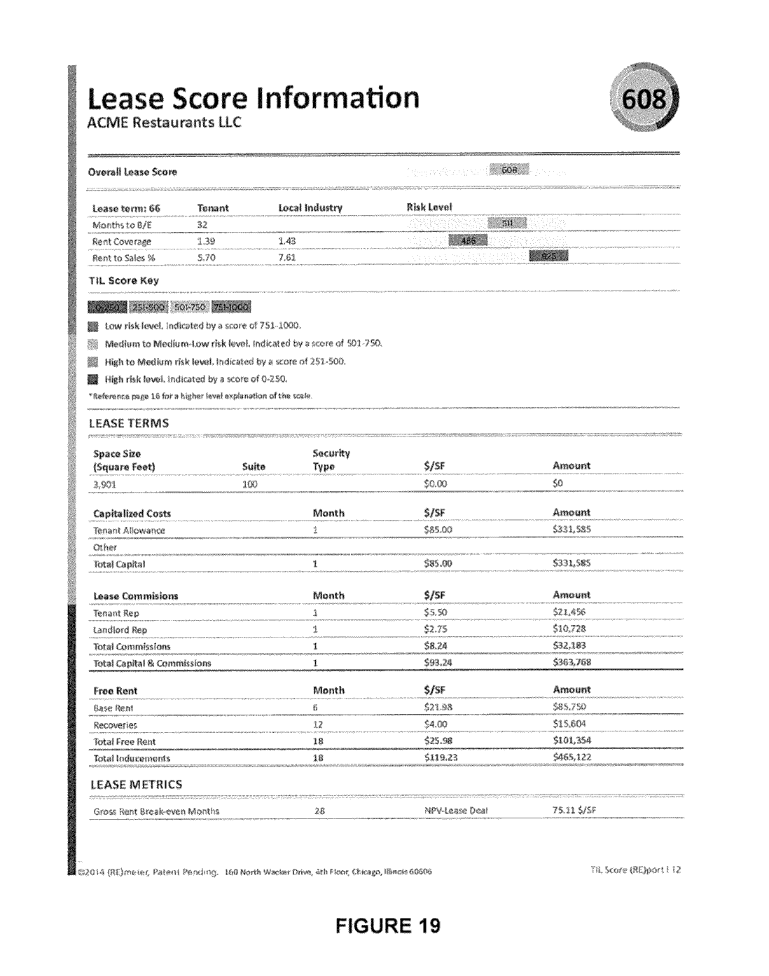

Lease Score information is summarized in FIG. 19, where the overall Lease ranking of 608 is correlated with respect to a months to break even ranking of 511, a rent coverage ranking of 486 and a rent to sales percentage of 925. Weighting is applied to those three rankings in order to arrive at the overall lease ranking of 608. The lease terms used to arrive at the above rankings include space size, captalized costs, lease commissions, free rent and gross rent break-even months.

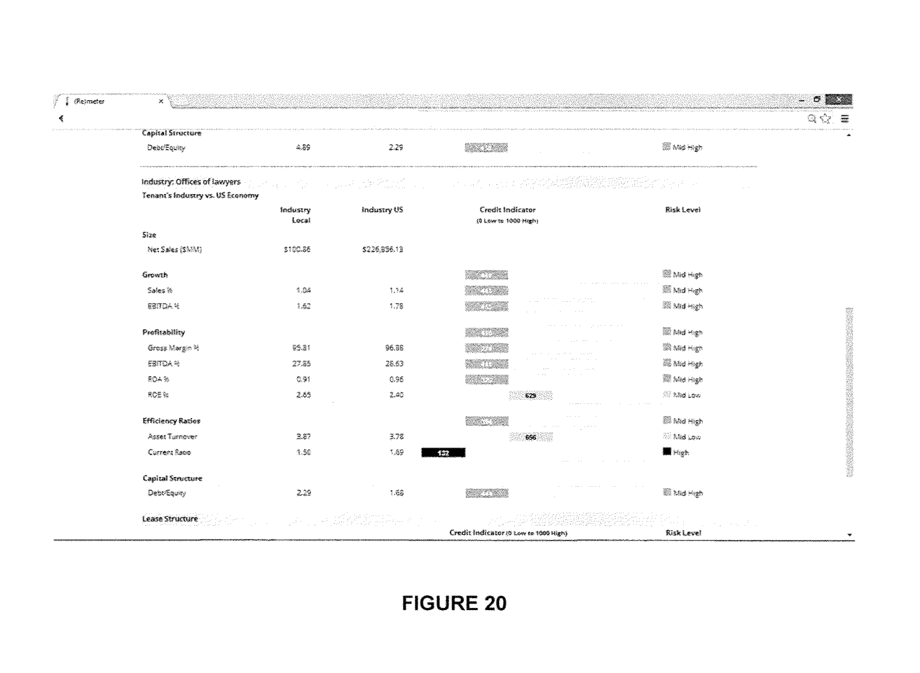

Turning to FIG. 20, a continuation of the Tenant assessment factors are depicted showing credit indicator score and risk level for the following data items for Tenant's industry vs. US economy: size, growth, profitability, efficiency ratios and capital structure.

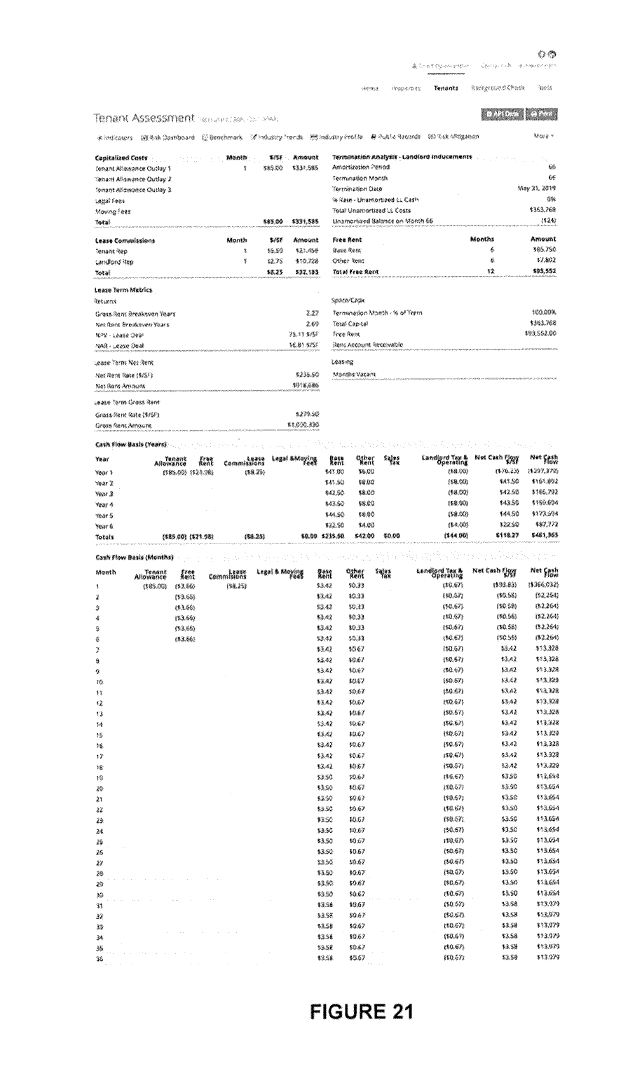

Turning to FIG. 21, a Tenant Assessment screen shot is depicted which requests information for Capitalized Costs including Tenant Allowance Outlay 13, Legal Fees, Moving Fees and a total. A Termination Analysis and Landlord Inducements category are provided including an Amortization Period, Termination Month, Termination Date, Percentage Rate on unamortized LL cash, Total Unamortized LL costs and Unamortized Balance on Month 66. Lease commissions are provided according to month, dollar per square footage and amount for the tenant rep landlord rep. Free rent is identified according to base rent and other rent by the month's and amount. Lease term metrics are inserted regarding returns, gross rent break-even years, net rent breakeven years and NPV lease deal and NAR lease deal.

Lease term metrics according to space per cap X termination month, percentage of term, total capital, free rent and rent account receivable are provided by screen shot of FIG. 21. Lease term net rent is provided by net rent rate and net rent amount, leasing months vacant is inserted leasing term gross rent according to gross rent rate dollar per square foot and gross rent amount are provided. Cash flow basis for years 1 through 6 are provided including tenant rent, allowance, free rent, lease commissions, legal and moving fees, base rent, other rent sales tax, landlord tax and operating data net cash flow by dollar per square foot and net cash flow total. Cash flow basis by months 1 through 36 are provided by the same categories as the cash flow basis by years.

FIG. 21, depicts a Tenant Assessment screen that provides for Tenant Financials including Type Accounting Method and Number of months covered. Income statement data includes Denomination, End of Fiscal Period, Net Revenue, Cost of Goods Sold, One Time in COGS, Adjusted Gross Profit, EBITDA, Net Income, Assets, Current Assets, Long-Term Assets, Total Assets, Current Liabilities, Long-Term Liabilities, Total Liabilities and Shareholders' Equity. Each of these data points require input for Current Period, Prior Period 1 and Prior Period 2 on FIG. 21.

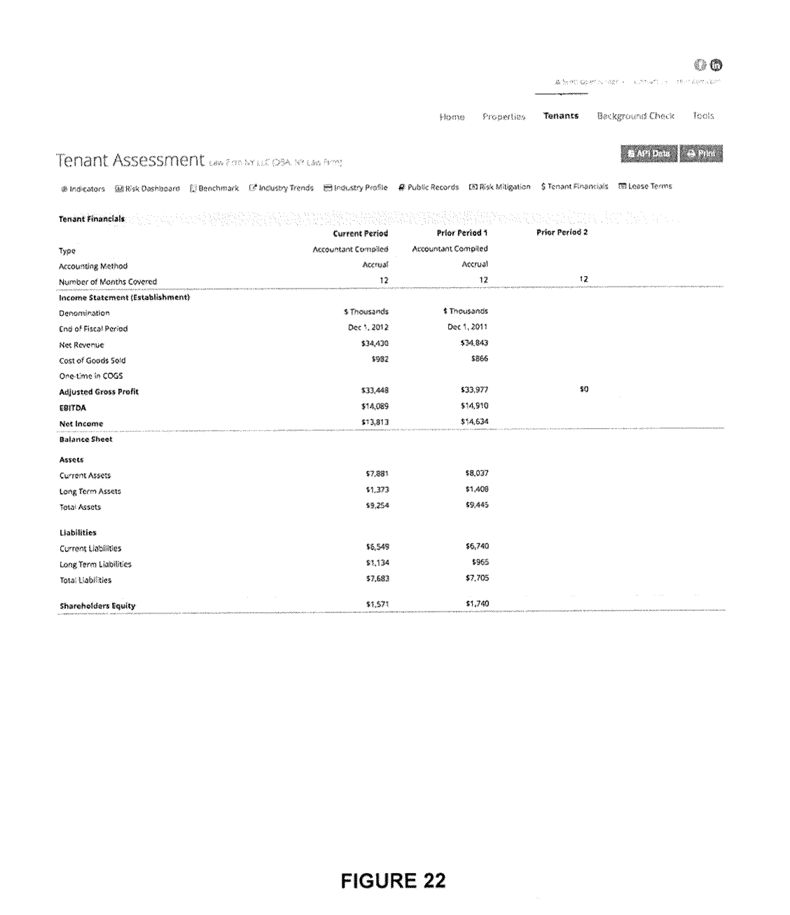

Turning to FIG. 22, a Tenant Assessment screen requests Proposed Lease Deal data including space size by square foot, rent break even, free rent, cash inducements, total inducements, free rent cash inducements for risk adjusted break even. Each of those data points are provided by Rate Per Square Foot, Monthly and Annual columns. Non-cash Inducements, such as free rent, are provided and cash inducements including tenant allowance outlay 1, tenant allowance outlay 2, tenant allowance outlay 3 and legal fees, moving fees, tenant rep commissions, landlord rep commission totals spent capital. Those data points are included by dollar per square foot and total amount.

The tenant assessment screen (FIG. 22) also includes risk options including security deposit reduction of rent, third-party options including corporate guarantee, personal guarantee, letter of credit, other items and totals. Each of these are provided according to amount by dollar per square foot, month of gross rent, risk reduction deferment, percent of cash inducements adjustment and adjusted value to be.

Turning to FIG. 22, the Tenant Assessment screen further requires Industry Analysis data by industry locale according to number of companies, Combined Revenue, average revenue, tenant revenue, revenues quotile, EBITDA quotile, new establishments, number of companies, combined revenue, average revenue, new establishments. Industry trends are provided by local number of establishments, national number of establishments, local number of employees, national number of employees, salaries are broken down by local payroll per net sales, national payroll by net sales, rent and occupancy costs are provided by local average rent, national average rent per employees provided by local rent per employee, national rent per employee and rent to sales are provided by local rent to sales percentage and national rent to sales percentage. Each of those data points are requested for the years 2010, 2011, 2012 and percent growth between 2010 vs. 2011 and percent growth 2011 vs. 2012.

This invention comprises machine readable storage having stored there on a computer program for determining financial rank. The computer program has a plurality of code sections executable by a machine for causing the machine to perform the steps of receiving the financial data collected from disparate data bases and transforming the data into a rank by comparing the industry information and financial data.

This invention could be embodied in other forms without departing from the spirit or essential attributes thereof and accordingly reference should be had to the following claims rather than the foregoing specification as indicating the scope of the invention.

What is claimed:

1. A method of displaying a credit score for a financial transaction comprising the steps of:
receiving at a computer server, financial data for a tenant via a data input module, the financial data having multiple data points;
receiving at the computer server, industry information via an industry peer group sorting module, the industry information having multiple data points;
receiving at the computer server, information relating to a lease structure for the tenant via the data input module;
comparing using the computer server, the multiple data points of the financial data to the multiple data points of the industry information via the benchmarking sub-process module in order to transform the financial data and industry information by establishing numeric benchmark values to derive a credit score with regard to financial factors related to the lease transaction;
recalculating using the computer server, via the recalculating module, the credit score based on the lease structure information; and
transmitting from the computer server, via the transmitting module, the modified credit score for display on a client machine.

2. The display method of claim 1 wherein the comparing provides a numeric credit score for a first lease transaction and the numeric credit score correlates with the percent by which the ranking exceeds its peers in a corresponding data set and the computer system for simultaneously processing thousands of lease transactions received from thousands of users and providing thousands of numeric credit scores based on thousands of data points of industry information.

3. The display method of claim 1 further comprising the steps of assigning an industry code based on an NAICS code to identify a particular industry and comparing the tenant with its peers based on the NAICS code and breaking out the ranking by one of a zip code, county, Metropolitan Statistical Area (MSA), state, region or nationally.

4. The display method of claim 1 wherein the numeric benchmark values are derived by comparing the frequency of a score of interest to each individual item and applying a weighting factor applied to the industry information being compared to determine the ranking.

5. The display method of claim 1 wherein the numeric benchmark values are derived by comparing the number of benchmarks that are less than a benchmark value percentile rank with the number of benchmarks which have the same value as the benchmark value of the percentile rank.

6. The display method of claim 5 wherein the numeric benchmark values are derived by a percentile rank via the percent ranking module according to the following formula:
$$PR = \frac{{f}_{b} + \frac{1}{2} fw}{N} * 100$$
where PR is the percent rank;
f_{b} is the frequency below the number of benchmarks which are less than the benchmark value percentile rank;
f_{w} is the frequency within the number of benchmarks which have the same value as the benchmark value of the percentile rank;
N is the number of benchmarks; and relative frequency is calculated according to the following formula:
$${f}_{b} = \frac{{n}_{i}}{\sum {n}_{i}}$$
where f_{b} is the frequency below; the number of benchmarks which are less than the benchmark value percentile rank;
n is the number of benchmarks.

7. The display method of claim 1 wherein the industry information includes government data comprising tax return data, the industry information pertaining to the industry of the tenant including multiple financial data points of comparable tenants.

8. The ranking method of claim 1 wherein the tax return data includes Internal Revenue Service data received from a database of at least 140 million individuals and 27 million businesses covering at least ten previous years of tax return data and the industry information includes one of employment data, household income data or local lease/rent data.

9. The display method of claim 1 wherein the industry information is incorporated with data from one of the U.S. Census Bureau and Bureau of Labor.

10. The display method of claim 1 wherein the ranking provides for one of: a) scoring of the tenant's financial performance; b) scoring of the tenant's industry financial performance; c) scoring of the lease structure for a commercial transaction; and d) ranking a lease transaction:

11. The display method of claim 1 further comprising the steps of adjusting a) lease structure, b) rent amount, c) lease mount, or d) break-even point, each in order to improve the ranking.

12. The display method of claim 1 further comprising the step of analyzing one of a global watch list, judgment database, liens database, criminal or civil court records, foreclosure records or bankruptcy filings in order to adjust the ranking.

13. The display method of claim 1 wherein the tenant financial data includes at least 250 data points for each lease transaction and the ranking scale is between 1 to 1000.

14. The display method of claim 1 wherein the ranking is used to determine a lower financial risk for the lease by varying geographic location, rent amount or break-even point.

15. The display method of claim 1 wherein the benchmark values are derived using one of a quintile scoring process, a linear interpolation and an order of magnitude process.

16. The display method of claim 1 wherein the ranking is used for one of providing peer to peer lease benchmarking, predicting likelihood of lease renewal, predicting likelihood of lease default, providing data to support issuance of default insurance for landlords; for determining potential business performance; determining risk level for a portfolio of leases or commercial loans; mitigating risk for a portfolio of leases, providing a risk-adjusted cap rate for a building sale or purchase; determining a rating for a commercial, industrial or retail REIT or determining a rating for a lease for a Commercial Mortgage Bank Security (CMBS).

17. A system for serving and creating a web page having a composite ranking display that incorporates elements from multiple sources, the system comprising: a computer server in communication with a computer network and automatically creating a web page or app having a composite ranking display; a first data input module receiving financial data for a tenant, the first data input module having hundreds of financial data points, the first data input module linked to the computer server; an industry peer group sorting module receiving industry data, the industry peer group sorting module having hundreds of industry data points, the industry peer group sorting module linked to the computer server; a second data input module receiving information relating to a lease structure for the tenant, the second data input module linked to the computer server; a benchmarking sub-process module automatically receives the industry and financial data points and compares the hundreds of industry and financial data points in order to transform the financial and industry data to establish a numeric benchmark value and to create a ranking display for the web page or app, providing a ranking with regard to the lease transaction; a recalculating module for recalculating the ranking based on the lease structure information and updating the web page or app with the recalculated ranking; and providing a graphical display on the webpage or app comprising a depiction of each of three following components that are combined to calculate the ranking; i) tenant score based on the financial data points; ii) industry score based on the industry data points; and iii) lease score based on the lease structure.

18. The system of claim 17 wherein the ranking provides a credit score for a lease transaction.

19. The system of claim 17 wherein the ranking supports credit score for a transaction that may be used by a credit bureau and a weighting factor applied to information being compared to determine the ranking.

20. The system of claim 17 wherein the industry information includes tax return data that includes Internal Revenue Service data received from a database of at least 140 million individuals and 27 million business covering at least ten previous years of tax return data.

21. The system of claim 17 wherein the ranking is used to adjust the lease structure, rent amount or break-even point in order to improve the ranking.
